(19) United States
(12) Patent Application Publication
(10) Pub. No.: US 2024/0221504 A1
(43) Pub. Date: Jul. 4, 2024

(54) PARKING GUIDANCE SYSTEM, PARKING GUIDANCE METHOD, AND NON-TRANSITORY COMPUTER-READABLE RECORDING MEDIUM

(71) Applicant: Sharp NEC Display Solutions, Ltd., Tokyo (JP)

(72) Inventor: Akira UCHIYAMA, Tokyo (JP)

(21) Appl. No.: 18/608,477

(22) Filed: Mar. 18, 2024

Related U.S. Application Data
(63) Continuation of application No. PCT/JP2021/038970, filed on Oct. 21, 2021.

(51) Int. Cl. G08G 1/14; G01C 21/36; G08G 1/01

(52) U.S. Cl. CPC G08G 1/143; G01C 21/3685; G01C 21/3691; G08G 1/0108; G08G 1/0133

(57) ABSTRACT

A parking guidance system includes: an acquisition unit configured to acquire route structure information indicating a structure on a route for a user of a facility to move from each of a plurality of parking areas to the facility, and selection information indicating information for selecting at least one parking area from among the plurality of parking areas; a parking area selection unit configured to select, from among the plurality of parking areas, a parking area that allows access to the facility through a route with a structure suitable for the user, based on the acquired route structure information and the acquired selection information; and an output processing unit configured to output to a display device, a content indicating the selected parking area as a guidance destination.

### TECHNICAL FIELD

The present invention relates to a parking guidance system, a parking guidance method, and a non-transitory computer-readable recording medium.

This application is a Continuation Application of International Application No. PCT/JP2021/038970, filed on Oct. 21, 2021, the contents of which are incorporated herein by reference.

### BACKGROUND ART

Conventionally, various techniques have been proposed for guiding a vehicle of a user to an empty parking space in a parking lot, taking into consideration convenience of the user.

For example, Patent Document 1 listed below discloses a technique for capturing a vehicle entering a parking lot at an entrance thereof and determining where in the parking lot the vehicle should be guided, based on information acquired from the captured image. Specifically, according to this technology, a vehicle width and the presence or absence of various signs attached to the vehicle, such as beginner driver signs, elderly driver signs, and wheelchair signs, are detected from the captured image, and the vehicle is guided to a parking space of a size according to the detected sign and vehicle width.

Further, Patent Document 2 listed below discloses a technique for capturing a license plate of a vehicle and a face of a passenger in the vehicle at an entrance of a parking lot, and determining where in the parking lot the vehicle should be guided, based on information acquired from the captured image. Specifically, according to the technology, the vehicle is guided to a parking space according to past data associated with the number detected from the captured image of the license plate and the characteristics of the passenger detected from the captured image of the face.

### PRIOR ART DOCUMENTS

### Patent Document

[Patent Document 1] Japanese Patent Application Publication No. 2007-048174
[Patent Document 2] Japanese Patent Application Publication No. 2017-157036

### SUMMARY OF THE INVENTION

### Problems to be Solved by the Invention

However, the techniques disclosed in Patent Document 1 and Patent Document 2 are techniques that only take into consideration the convenience until the time users park their vehicles in vacant parking spaces within one parking lot. Some users find it more convenient to take into consideration the convenience when moving from the parking lot to a facility they are using. A facility such as a large facility or a complex facility consisting of plural facilities (for example, commercial facility) may have plural parking lots. In this case, depending on which parking lot a user parks a vehicle, the convenience when the user moves from the parking lot to the facility after parking the vehicle differs. For example, a parking lot with barrier-free access between the parking lot and the facility may be more convenient for users. During bad weather, an indoor parking lot or a parking lot with a covered passage may be more convenient for users.

In view of the above-described problems, an object of the present invention is to provide a parking guidance system, a parking guidance method, and a non-transitory computer-readable recording medium that can improve the convenience when users of a parking area move from the parking area where their vehicles are parked to a facility.

### Means for Solving the Problems

To solve the above-described problems, a parking guidance system according to an aspect of the present invention includes: an acquisition unit configured to acquire route structure information indicating a structure on a route for a user of a facility to move from each of a plurality of parking areas to the facility, and selection information indicating information for selecting at least one parking area from among the plurality of parking areas; a parking area selection unit configured to select, from among the plurality of parking areas, a parking area that allows access to the facility through a route with a structure suitable for the user, based on the acquired route structure information and the acquired selection information; and an output processing unit configured to output to a display device, a content indicating the selected parking area as a guidance destination.

A parking guidance method according to an aspect of the present invention includes: acquiring route structure information indicating a structure on a route for a user of a facility to move from each of a plurality of parking areas to the facility, and selection information indicating information for selecting at least one parking area from among the plurality of parking areas; selecting, from among the plurality of parking areas, a parking area that allows access to the facility through a route with a structure suitable for the user, based on the acquired route structure information and the acquired selection information; and outputting to a display device, a content indicating the selected parking area as a guidance destination.

A non-transitory computer-readable recording medium according to an aspect of the present invention stores a program causing a computer to: acquire route structure information indicating a structure on a route for a user of a facility to move from each of a plurality of parking areas to the facility, and selection information indicating information for selecting at least one parking area from among the plurality of parking areas; select, from among the plurality of parking areas, a parking area that allows access to the facility through a route with a structure suitable for the user, based on the acquired route structure information and the acquired selection information; and output to a display device, a content indicating the selected parking area as a guidance destination.

### Effects of the Invention

According to the present invention, it is possible to improve the convenience when users of a parking area move from the parking area where their vehicles are parked to a facility.

### BRIEF DESCRIPTION OF THE DRAWINGS

FIG. 1 is a diagram showing an example of a configuration of a parking guidance system according to the present embodiment.

FIG. 2 is a block diagram showing an example of a functional configuration of a display device according to the present embodiment.

FIG. 3 is a block diagram showing an example of a functional configuration of an imaging device according to the present embodiment.

FIG. 4 is a block diagram showing an example of a functional configuration of a parking guidance device according to the present embodiment.

FIG. 5 is a diagram showing an example of a data structure of facility information according to the present embodiment.

FIG. 6 is a diagram showing an example of a content according to the present embodiment.

FIG. 7 is a sequence diagram showing an example of a flow of processing by the parking guidance system according to the present embodiment.

FIG. 8 is a flowchart showing an example of a flow of processing by the parking guidance device according to the present embodiment.

FIG. 9 is a diagram showing an example of a content in a modified example of the present embodiment.

FIG. 10 is a block diagram showing an example of a configuration of a parking guidance system according to another embodiment.

### MODE FOR CARRYING OUT THE INVENTION

Hereinafter, embodiments of the present invention will be described in detail with reference to the drawings. A parking guidance system according to the present embodiment is a system for providing a service that guides a user, who uses a vehicle as means of transportation to a facility, to a parking area suitable for the user (hereinafter also referred to as “parking guidance service”). In the present embodiment, an example will be described in which the parking guidance system regards one entire parking lot as one parking area and guides a user to a parking lot suitable for the user among a plurality of parking lots. Further, in the present embodiment, it is assumed that one facility has a plurality of parking lots that can be used by users. Therefore, in the present embodiment, the parking guidance system guides a user to a parking lot suitable for the user among the plurality of parking lots, taking into consideration the convenience until the time the user moves from the parking lot where the user parks a vehicle to an entrance of the facility.

Examples of the facility include a commercial facility, an entertainment facility, a sports facility, a medical facility, an educational facility, a cultural facility, a public facility, and the like. The facility may be a complex facility such as a shopping mall. Note that the complex facility may be a complex facility in which a plurality of facilities of one type are gathered together, or may be a complex facility in which a plurality of facilities of a plurality of types are gathered together. In the present embodiment, an example in which the facility is a shopping mall will be described.

Examples of the vehicle include a car, a motorized bicycle, a bicycle, and the like. The car includes a passenger car, a bus, a truck, a motorcycle, or the like. In the present embodiment, an example in which the vehicle is a car will be described.

The parking lot is a flat parking lot or a multi-level parking lot. In the present embodiment, an example in which the parking lot is a flat parking lot will be described. Note that the plurality of parking lots in the present embodiment may be a plurality of parking lots within the premise of the facility, a plurality of parking lots outside the premise of the facility, or a plurality of parking lots that are a combination of a parking lot within the premise of the facility and a parking lot outside the premise thereof.

### <1. Configuration of Parking Guidance System>

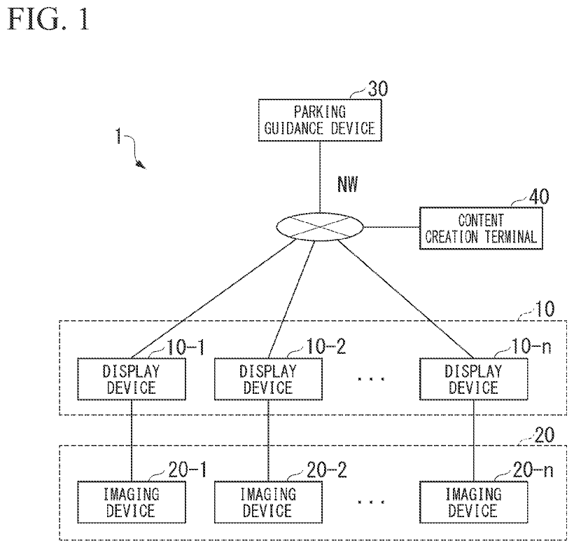

First, a configuration of a parking guidance system according to the present embodiment will be described with reference to FIG. 1. FIG. 1 is a diagram showing an example of the configuration of the parking guidance system according to the present embodiment.

As shown in FIG. 1, a parking guidance system 1 includes display devices 10-1 to 10-n (n is a natural number), imaging devices 20-1 to 20-n, a parking guidance device 30, and a content creation terminal 40.

Note that hereinafter, when the display devices 10-1 to 10-n are not distinguished, “display device 10” will be used as a generic term for the display devices 10-1 to 10-n. Further, hereinafter, when the imaging devices 20-1 to 20-n are not distinguished, “imaging device 20” will be used as a generic term for the imaging devices 20-1 to 20-n.

### (1) Display Device 10

The display device 10 is a device that displays contents. Examples of the display device 10 include a liquid crystal display, a plasma display, an organic EL (Organic Electro-Luminescence) display, an LED (Light Emitting Diode) display, and the like. Further, the display device 10 is not limited to a display, and may be a projector, for example. In a case of a projector, contents are displayed by projecting the contents from the projector onto a screen, a wall, or the like.

The display devices 10-1 to 10-n are connected to the imaging devices 20-1 to 20-n, respectively. For example, the display device 10-1 is connected to the imaging device 20-1, the display device 10-2 is connected to the imaging device 20-2, and the display device 10-n is connected to the imaging device 20-n. The display devices 10-1 to 10-n receive images captured by the imaging devices 20-1 to 20-n from the imaging devices 20-1 to 20-n connected to the display devices 10-1 to 10-n, respectively.

Note that the display devices 10-1 to 10-n are connected to the imaging devices 20-1 to 20-n, respectively, through wireless connection or wired connection using a USB (Universal Serial Bus) cable or the like.

The display device 10 detects various information based on the image received from the imaging device 20. For example, the display device 10 detects a vehicle from the received image, or detects an attribute of a user riding in the vehicle.

Further, each of the display devices 10-1 to 10-n is connected to the parking guidance device 30, and transmits to the parking guidance device 30, a content request and information indicating an attribute of a detected user (hereinafter also referred to as “attribute information”). Further, each of the display devices 10-1 to 10-n receives a content from the parking guidance device 30 and displays the received content. Note that each of the display devices 10-1 to 10-n is connected to the parking guidance device 30 via a network NW by wired connection or wireless connection.

The display device 10 displays a content for guiding a user (vehicle) to a parking lot. The content is, for example, an image (still image or moving image) in which a guidance destination parking lot is displayed on a map indicating a position of a facility, positions of the plurality of parking lots, and a current position of the user. The display device 10 is provided, for example, near an entrance to a premise of a facility, near an entrance to each parking lot, near an entrance to a premise including the plurality of parking lots, or on a public road.

Note that the position where the display device 10 is provided is preferably a position where a vehicle stops, so that a user riding in the vehicle can easily view the content. For example, the display device 10 is preferably provided near each entrance where an entrance gate is installed. Further, the display device 10 is preferably installed near a traffic light on a public road.

### (2) Imaging Device 20

The imaging device 20 is a device that captures images (still images or moving images), and is a camera, for example. The imaging device 20 is connected to the display device 10, and transmits an image captured (hereinafter also referred to as a “captured image”) to the display device 10 to which the own imaging device 20 is connected. Note that the imaging device 20 may be built into the display device 10 or may be externally connected.

The imaging device 20 is provided at a position where the imaging device 20 can capture a vehicle passing around the display device 10. Specifically, the imaging device 20 is provided at a position where the imaging device 20 can capture a vehicle moving in front of the display device 10 (on a display surface side). More specifically, the imaging device 20 is preferably provided so as to be able to capture an image showing at least one of an exterior and an interior of the vehicle. In the present embodiment, an example will be described in which the imaging device 20 captures only an image showing the exterior of the vehicle.

### (3) Parking Guidance Device 30

The parking guidance device 30 is a server device that can communicate with the display device 10 and the content creation terminal 40. The parking guidance device 30 may be a server owned by a business that provides the parking guidance service, or may be a cloud server.

The parking guidance device 30 communicates information regarding the parking guidance service with the display device 10 and with the content creation terminal 40. For example, the parking guidance device 30 receives from the display device 10 via the network NW, a request for the content to be displayed by the display device 10, and the attribute information detected by the display device 10. Further, the parking guidance device 30 receives the content created by the content creation terminal 40 from the content creation terminal 40 via the network NW. Further, the parking guidance device 30 transmits to the display device 10 via the network NW, a content selected based on the information received from the display device 10.

### (4) Content Creation Terminal 40

The content creation terminal 40 is a terminal used by a content creator. The content creation terminal 40 includes an input device (mouse, keyboard, touch panel, etc.), an output device (display, etc.), an output device (speaker, data output function), a central processing unit, and the like. The content creation terminal 40 may be any terminal such as a computer, a smartphone, or a tablet, for example.

The contents according to the present embodiment are created in advance by a content creator and registered (stored) in the parking guidance device 30 in advance. The content creator may be, for example, a person belonging to a business providing the parking guidance service, or a person outsourced from the business.

The content creation terminal 40 receives an operational input from the creator via the input device, creates a content according to the input information, and transmits the created content to the parking guidance device 30. Thereby, the created content is registered (stored) in the parking guidance device 30.

### <2. Functional Configuration of Display Device>

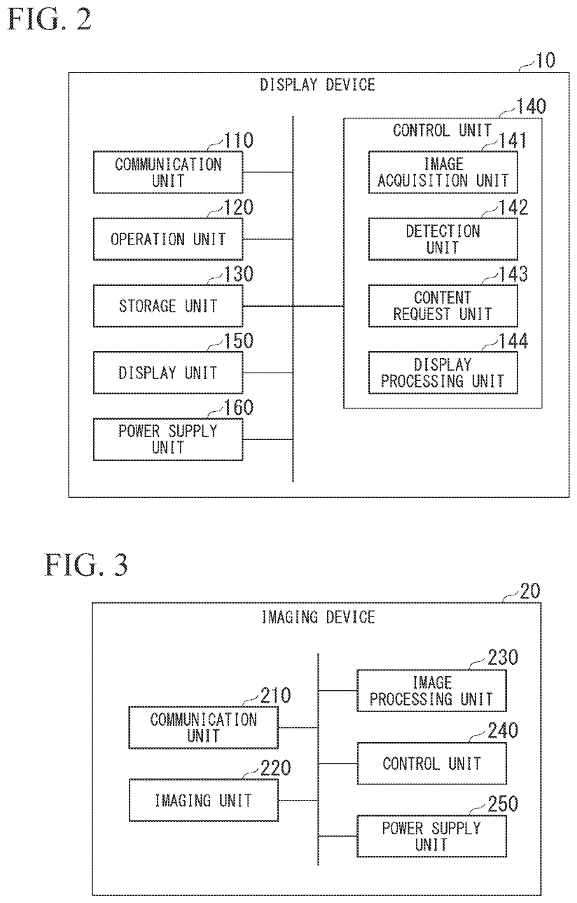

The configuration of the parking guidance system 1 according to the present embodiment has been described above. Next, a functional configuration of the display device 10 according to the present embodiment will be described with reference to FIG. 2. FIG. 2 is a block diagram showing an example of the functional configuration of the display device 10 according to the present embodiment.

As shown in FIG. 2, the display device 10 includes a communication unit 110, an operation unit 120, a storage unit 130, a control unit 140, a display unit 150, and a power supply unit 160.

### (1) Communication Unit 110

The communication unit 110 has a function of transmitting and receiving various information. The communication unit 110 is a communication circuit that communicates with a communication partner via wireless or wired communication. For example, the communication unit 110 receives a captured image from the imaging device 20 connected to the own display device. Further, the communication unit 110 transmits a content request and attribute information to the parking guidance device 30 via the network NW, and receives a content from the parking guidance device 30.

### (2) Operation Unit 120

The operation unit 120 receives an input from a user. The user is, for example, an administrator of the display device 10. The operation unit 120 includes, for example, keys and buttons arranged on the display device 10, a touch panel, a remote controller, and various pointing devices.

### (3) Storage Unit 130

The storage unit 130 has a function of storing various information. The storage unit 130 is composed of a storage medium included in the display device 10 as hardware, such as an HDD (Hard Disk Drive), an SSD (Solid State Drive), a flash memory, an EEPROM (Electrically Erasable Programmable Read Only Memory), or a RAM (Random Access read/write Memory), a ROM (Read Only Memory), or any combination of these storage media.

For example, the storage unit 130 stores in advance position information indicating the position where the display device 10 is installed. Further, the storage unit 130 stores the detected attribute information and the content received from the parking guidance device 30.

### (4) Control Unit 140

The control unit 140 has a function of controlling the overall operation of the display device 10. The control unit 140 is realized, for example, by causing a CPU (Central Processing Unit) included in the display device 10 as hardware to execute a program.

As shown in FIG. 2, the control unit 140 includes an image acquisition unit 141, a detection unit 142, a content request unit 143, and a display processing unit 144.

### (4-1) Image Acquisition Unit 141

The image acquisition unit 141 has a function of acquiring images. For example, the image acquisition unit 141 acquires the captured image that the communication unit 110 receives from the imaging device 20. The image acquisition unit 141 outputs the acquired captured image to the detection unit 142.

### (4-2) Detection Unit 142

The detection unit 142 has a function of detecting attributes of users. For example, the detection unit 142 detects an attribute of the user riding in the vehicle from the captured image acquired by the image acquisition unit 141. In the present embodiment, the captured image acquired by the image acquisition unit 141 is an image capturing the exterior of the vehicle. Further, in the present embodiment, the attribute detected by the detection unit 142 is, for example, one of the elderly, the disabled, and the infant.

The detection unit 142 detects a vehicle from the captured image acquired by the image acquisition unit 141. When a vehicle is detected, the detection unit 142 detects an attribute of the user based on the captured image from which the vehicle is detected. For example, the detection unit 142 detects a sign displayed on the vehicle shown in the captured image, and detects an attribute of the user riding in the vehicle based on the detected sign. Specifically, when the detected sign is an elderly driver sign, the detection unit 142 detects that the user is an elderly person, as an attribute of the user. Further, when the detected sign is a hearing-impaired person sign or a physically handicapped person sign, the detection unit 142 detects that the user is a disabled person, as an attribute of the user. Further, when the detected sign is a sign indicating that an infant is on board, the detection unit 142 detects that the user is an infant, as an attribute of the user.

When detecting an attribute of the user, the detection unit 142 writes and stores information indicating the detected attribute as attribute information in the storage unit 130.

The signs displayed on vehicles are signs displayed by users of their own will in order to make their attributes known to those around them. Therefore, by the detection unit 142 detecting attributes of users based on the signs displayed on the vehicles, it is possible to provide the parking guidance service according to the present embodiment to the users who are seeking services corresponding to their own attributes.

### (4-3) Content Request Unit 143

The content request unit 143 has a function of requesting contents. For example, the content request unit 143 transmits a content request from the communication unit 110 to the parking guidance device 30 when the detection unit 142 detects a vehicle.

Note that when the detection unit 142 detects a vehicle, the content request unit 143 transmits a content request from the communication unit 110 to the parking guidance device 30, regardless of whether or not the detection unit 142 detects an attribute of the user. When an attribute of the user is detected by the detection unit 142, the content request unit 143 includes attribute information indicating the detected attribute in a content request and transmits the content request from the communication unit 110 to the parking guidance device 30.

### (4-4) Display Processing Unit 144

The display processing unit 144 has a function of controlling the display on the display unit 150. For example, the display processing unit 144 causes the display unit 150 to display the content that the communication unit 110 receives from the parking guidance device 30.

### (5) Display Unit 150

The display unit 150 has a function of displaying various information. The display unit 150 is realized, for example, by a display included in the display device 10 as hardware. The display unit 150 displays contents, for example.

### (6) Power Supply Unit 160

The power supply unit 160 has a function of supplying power to each unit of the display device 10.

### <3. Functional Configuration of Imaging Device>

The functional configuration of the display device 10 according to the present embodiment has been described above. Next, a functional configuration of the imaging device 20 according to the present embodiment will be described with reference to FIG. 3. FIG. 3 is a block diagram showing an example of the functional configuration of the imaging device 20 according to the present embodiment.

As shown in FIG. 3, the imaging device 20 includes a communication unit 210, an imaging unit 220, an image processing unit 230, a control unit 240, and a power supply unit 250.

### (1) Communication Unit 210

The communication unit 210 has a function of transmitting and receiving various information. The communication unit 210 is a communication circuit that communicates with a communication partner via wireless or wired communication. For example, the communication unit 210 transmits a captured image to the display device 10 connected to the own imaging device.

### (2) Imaging Unit 220

The imaging unit 220 has a function of capturing an image showing at least one of the exterior and the interior of the vehicle. For example, the imaging unit 220 outputs the captured image to the communication unit 210 or the image processing unit 230. In the present embodiment, an example will be described in which the imaging unit 220 captures only an image showing the exterior of the vehicle.

### (3) Image Processing Unit 230

The image processing unit 230 has a function of performing image processing. For example, the image processing unit 230 processes the captured image captured by the imaging unit 220.

### (4) Control Unit 240

The control unit 240 has a function of controlling the overall operation of the imaging device 20. The control unit 240 is realized, for example, by causing a CPU included in the imaging device 20 as hardware to execute a program.

### (5) Power Supply Unit 250

The power supply unit 250 has a function of supplying power to each unit of the imaging device 20.

### <4. Functional Configuration of Parking Guidance Device>

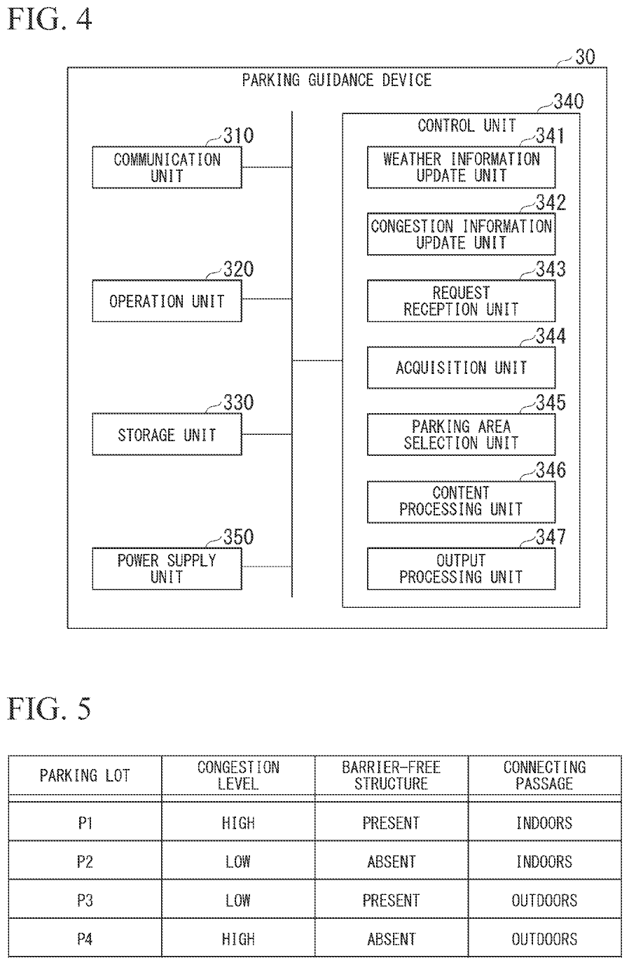

The functional configuration of the imaging device 20 according to the present embodiment has been described above. Next, a functional configuration of the parking guidance device 30 according to the present embodiment will be described with reference to FIGS. 4 to 6. FIG. 4 is a block diagram showing an example of the functional configuration of the parking guidance device 30 according to the present embodiment.

As shown in FIG. 4, the parking guidance device 30 includes a communication unit 310, an operation unit 320, a storage unit 330, a control unit 340, and a power supply unit 350.

### (1) Communication Unit 310

The communication unit 310 has a function of transmitting and receiving various information. The communication unit 310 is a communication circuit that communicates with a communication partner via wireless or wired communication. For example, the communication unit 310 receives a content request from the display device 10. Further, the communication unit 310 receives the content created by the content creation terminal 40 from the content creation terminal 40. Further, the communication unit 310 transmits to the display device 10, a content to be displayed on the display device 10.

### (2) Operation Unit 320

The operation unit 320 receives an input from a user. The user is, for example, an administrator of the parking guidance device 30 or a business providing the parking guidance service. The operation unit 320 includes, for example, keys and buttons arranged on the parking guidance device 30, a touch panel, a remote controller, and various pointing devices.

### (3) Storage Unit 330

The storage unit 330 has a function of storing various information. The storage unit 330 is composed of a storage medium included in the parking guidance device 30 as hardware, such as an HDD, an SSD, a flash memory, an EEPROM, a RAM, or a ROM, or any combination of these storage media.

The storage unit 330 stores, for example, weather information, facility information, and the content created by the content creation terminal 40.

The weather information is information indicating the weather at the facility and the plurality of parking lots. The storage unit 330 may create a table to store the weather information, or may simply convert the weather information into a character string and store the character string.

The facility information is information related to facilities, and is, for example, information prepared for each facility. The facility information includes parking lot information, congestion information, and route structure information.

The parking lot information is information indicating the plurality of parking lots that can be used by facility users. The congestion information is information indicating a congestion level of each of the plurality of parking lots. The route structure information is information indicating a structure on a route for a user of a facility to move from each of the plurality of parking lots to the facility (hereinafter also referred to as a “travel route”).

The route structure information includes, for example, information indicating the presence or absence of a barrier-free structure on the travel route. Examples of the barrier-free structure include passages from which steps have been eliminated and which have been installed with slopes, elevators, handrails, and the like for the elderly, wheelchair users, and stroller users, and passages installed with Braille blocks for the visually impaired.

Further, the route structure information includes information indicating whether or not a connecting passage is provided with at least a roof. Hereinafter, in the present embodiment, it is assumed that a connecting passage provided with at least a roof is an indoor connecting passage, regardless of whether it is surrounded by a wall or not. On the other hand, it is assumed that a connecting passage without a roof is an outdoor connecting passage.

Here, a data structure of the facility information will be explained with reference to FIG. 5. FIG. 5 is a diagram showing an example of the data structure of the facility information according to the present embodiment.

As shown in FIG. 5, the facility information a data structure including the parking lot information indicating the plurality of parking lots that can be used by facility users, the congestion information indicating a congestion level of each parking lot, and the route structure information indicating the presence or absence of a barrier-free structure and whether a connecting passage is indoors or outdoors.

FIG. 5 shows an example of the facility information of a facility that has four parking lots P1 to P4.

A first record contains registered data indicating that the parking lot is P1, that the congestion level of the parking lot P1 is high, that there is a barrier-free structure on a route from the parking lot P1 to the facility, and that a connecting passage is indoors.

A second record contains registered data indicating that the parking lot is P2, that the congestion level of the parking lot P2 is low, that there is no barrier-free structure on a route from the parking lot P2 to the facility, and that a connecting passage is indoors.

A third record contains registered data indicating that the parking lot is P3, that the congestion level of the parking lot P3 is low, that there is a barrier-free structure on a route from the parking lot P3 to the facility, and that a connecting passage is outdoors.

A fourth record contains registered data indicating that the parking lot is P4, that the congestion level of the parking lot P4 is high, that there is no barrier-free structure on a route from the parking lot P4 to the facility, and that a connecting passage is outdoors.

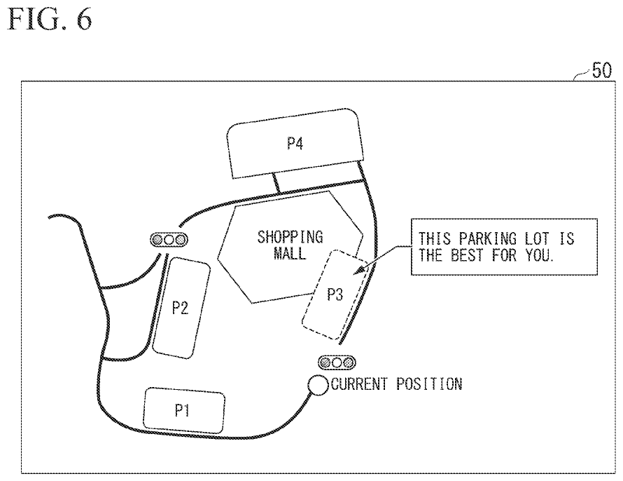

Here, a content stored in the storage unit 330 and displayed on the display device 10 will be described with reference to FIG. 6. FIG. 6 is a diagram showing an example of the content according to the present embodiment.

As shown in FIG. 6, a content 50 is an image in which a sign indicating that the parking lot P3 is the guidance destination parking lot is displayed on a map showing the position of the shopping mall (an example of the facility), the positions of the parking lots P1 to P4, and the current position of the user. In FIG. 6, the parking lot P3 is colored and is added with a speech bubble with the words “This parking lot is the best for you.” In this way, the guidance destination parking lot can be easily understood by highlighting it with color or adding a speech bubble.

### (4) Control Unit 340

The control unit 340 has a function of controlling the overall operation of the parking guidance device 30. The control unit 340 is realized, for example, by causing a CPU included in the parking guidance device 30 as hardware to execute a program.

As shown in FIG. 4, the control unit 340 includes a weather information update unit 341, a congestion information update unit 342, a request reception unit 343, an acquisition unit 344, a parking area selection unit 345, a content processing unit 346, and an output processing unit 347.

### (4-1) Weather Information Update Unit 341

The weather information update unit 341 has a function of updating the weather information. The weather information is information that is likely to change frequently. Therefore, the weather information update unit 341 periodically acquires and updates the weather information (for example, every 5 minutes).

The weather information update unit 341 may acquire the weather information by various means. For example, the weather information update unit 341 acquires the latest weather information using an API (Application Programming Interface) service that can acquire information announced by the Japan Meteorological Agency in a JSON (JavaScript Object Notation) format or the like. Then, the weather information update unit 341 updates the weather information stored in the storage unit 330 with the acquired weather information.

### (4-2) Congestion Information Update Unit 342

The congestion information update unit 342 has a function of updating the congestion information. The congestion information is information that is likely to change frequently. Therefore, the congestion information update unit 342 periodically acquires and updates the congestion information (for example, every 5 minutes).

The congestion information update unit 342 may acquire the congestion information by various means. For example, a sensor capable of detecting the presence or absence of a parked vehicle is attached to each parking unit of each parking lot. The congestion information update unit 342 acquires, as the congestion information, a congestion state detected from a difference between the maximum accommodating number of vehicles and the actual number of parked vehicles from a result of the detection by each sensor. Then, the congestion information updating unit 342 updates the congestion information included in the facility information stored in the storage unit 330 with the acquired congestion information.

### (4-3) Request Reception Unit 343

The request reception unit 343 has a function of receiving requests. For example, the request reception unit 343 receives a content request from the display device 10.

### (4-4) Acquisition Unit 344

The acquisition unit 344 has a function of acquiring various information. For example, the acquisition unit 344 acquires route structure information and selection information. The route structure information is the route structure information included in the facility information stored in the storage unit 330. The selection information is information for selecting at least one parking lot from the plurality of parking lots. Specifically, the acquisition unit 344 acquires at least one of the congestion information, the weather information, and the attribute information as the selection information. As an example, the acquisition unit 344 acquires at least the congestion information and the weather information as the selection information, and when the attribute information is included in the content request, also acquires the attribute information as the selection information. Then, the acquisition unit 344 outputs the acquired route structure information and selection information to the parking area selection unit 345.

### (4-5) Parking Area Selection Unit 345

The parking area selection unit 345 has a function of selecting a parking lot to which a user is guided. For example, based on the route structure information and selection information acquired by the acquisition unit 344, the parking area selection unit 345 selects from among the plurality of parking lots, a parking lot that allows access to the facility through a travel route that has a structure suitable for the user.

When the congestion information is acquired as the selection information, the parking area selection unit 345 selects a parking lot according to whether the congestion level indicated by the acquired congestion information is high or low. Specifically, the parking area selection unit 345 selects a parking lot with the low congestion level preferentially over a parking lot with the high congestion level.

As a result, the user is guided to a parking lot with the low congestion level. Therefore, compared to a case where the user is guided to a parking lot with the high congestion level, the time it takes to park the car can be shortened.

Therefore, it is possible to improve the convenience until the time the facility users park their vehicles in the parking lots.

When the weather information is acquired as the selection information, the parking area selection unit 345 selects a parking lot according to whether or not the travel route is provided with a structure corresponding to the weather indicated by the acquired weather information. Specifically, when the acquired weather information indicates a weather condition under which an indoor connecting passage (a route provided with at least a roof) is preferable, the parking area selection unit 345 selects a parking lot that allows access to the facility through the route provided with the indoor connecting passage.

Examples of the weather condition under which a route provided with an indoor connecting passage is preferable include weather accompanied by rain, snow, sleet, hail, or the like, and weather accompanied by thunder. Hereinafter, in the present embodiment, when the weather information indicates the weather condition under which a route provided with an indoor connecting passage is preferable, the weather condition is referred to as “bad.”

In this way, when the weather condition is “bad,” the user is guided to a parking lot that allows access to the facility through a route provided with an indoor connecting passage. Thereby, the user can avoid rain, snow, sleet, hail, wind, lightning, and like, and move from the parking lot to the facility by passing through the indoor connecting passage after parking. Therefore, it is possible to improve the convenience when users of a facility move from the parking lots where their vehicles are parked to the facility.

On the other hand, when the acquired weather information indicates a weather condition under which an indoor connecting passage is not necessary, the parking area selection unit 345 may select either a parking lot that allows access to the facility through a route provided with an outdoor connecting passage or a parking lot that allows access to the facility through a route provided with an indoor connecting passage. Therefore, in this case, the parking area selection unit 345 may use selection information other than the weather information preferentially over the weather information to select a parking lot.

Examples of the weather condition under which an indoor connecting passage is not necessary include sunny weather, cloudy weather, and the like. Hereinafter, in the present embodiment, when the weather information indicates the weather condition under which an indoor connecting passage is not necessary, the weather condition is referred to as “good.”

When the attribute information is acquired as the selection information, the parking area selection unit 345 selects a parking lot according to whether or not the route is provided with a structure corresponding to an attribute of a user indicated by the acquired attribute information. Specifically, when the acquired attribute information indicates that a route provided with a barrier-free structure is preferable, the parking area selection unit 345 selects a parking lot that allows access to the facility through a route provided with a barrier-free structure.

As a result, elderly people, wheelchair users, stroller users, or the like will be guided to a parking lot that allows access to the facility through a route provided with a barrier-free structure. Therefore, users can move from the parking lot to the facility more easily than when they were guided to a parking lot that allows access to the facility through a route provided with no barrier-free structure.

Therefore, it is possible to improve the convenience when users of a facility who prefer a route provided with a barrier-free structure move from the parking lots where their vehicles are parked to the facility.

Note that when plural information pieces among the congestion information, the weather information, and the attribute information are acquired as the selection information, the parking area selection unit 345 combines the above-described processes according to the acquired information pieces to select a parking lot. For example, when the congestion information and the weather information are acquired as the selection information, the parking area selection unit 345 first selects parking lots with the low congestion level based on the congestion information. Next, the parking area selection unit 345 selects a parking lot corresponding to the weather condition based on the weather information from among the parking lots selected based on the congestion information.

Further, when the attribute information is also acquired as the selection information, the parking area selection unit 345 selects a parking lot corresponding to the attribute of the user based on the attribute information from among the parking lots selected based on the congestion information and the weather information.

### (4-6) Content Processing Unit 346

The content processing unit 346 has a function of performing processing related to contents. For example, the content processing unit 346 acquires from the storage unit 330, a content in which the parking lot selected by the parking area selection unit 345 is indicated as the guidance destination. Then, the content processing unit 346 outputs the acquired content to the output processing unit 347.

### (4-7) Output Processing Unit 347

The output processing unit 347 has a function of outputting contents. For example, the output processing unit 347 transmits the content acquired by the content processing unit 346 from the communication unit 310 to the display device 10, and outputs the content to the display device 10.

As a result, the content in which the parking lot selected as the parking lot suitable for the user is indicated as the guidance destination is displayed on the display device 10. Then, a user can confirm the content displayed on the display device 10, move to the parking lot suitable for the user, and park the vehicle.

### (5) Power Supply Unit 350

The power supply unit 350 has a function of supplying power to each unit of the parking guidance device 30.

### <5. Processing Flow>

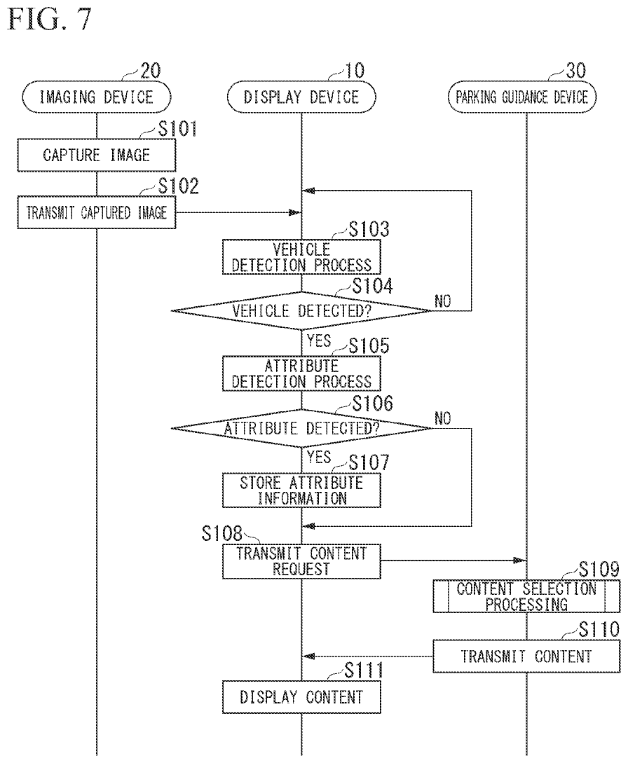

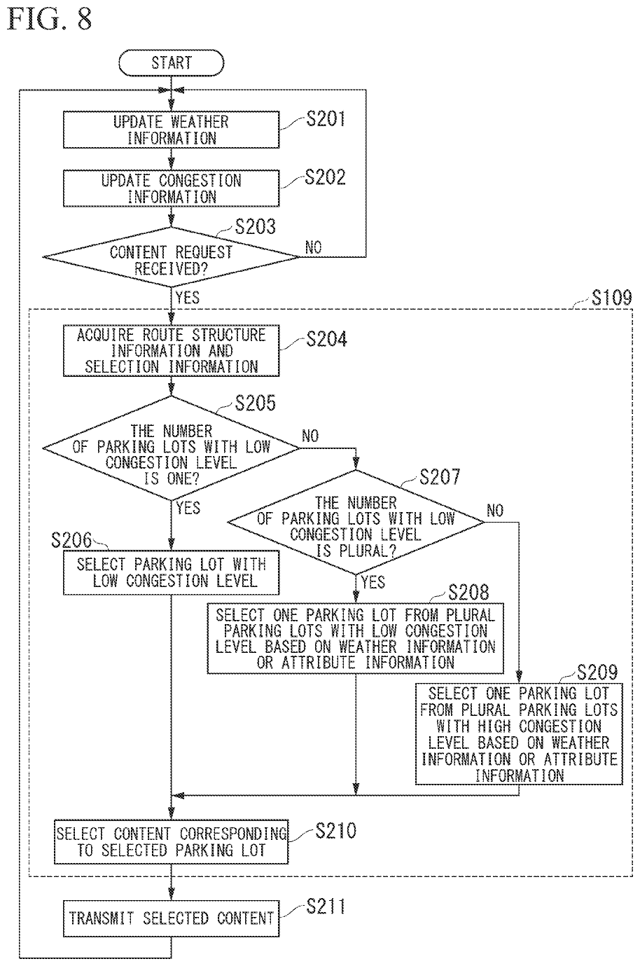

The functional configuration of the parking guidance device 30 according to the present embodiment has been described above. Next, a flow of processing according to the present embodiment will be described with reference to FIGS. 7 and 8.

### (1) Flow of Processing by Parking Guidance System 1

First, a flow of processing by the parking guidance system 1 will be described with reference to FIG. 7. FIG. 7 is a sequence diagram showing an example of the flow of the processing by the parking guidance system 1 according to the present embodiment.

As shown in FIG. 7, first, the imaging device 20 captures an image (step S101). For example, the imaging device 20 captures an image of space in a direction in which the imaging device 20 is facing.

After the capturing, the imaging device 20 transmits the captured image obtained by the capturing to the display device 10 (step S102).

Upon receiving the captured image from the imaging device 20, the display device 10 performs a vehicle detection process based on the captured image (step S103). Specifically, the image acquisition unit 141 acquires the captured image received by the communication unit 110, and the detection unit 142 detects a vehicle based on the captured image acquired by the image acquisition unit 141.

When a vehicle is detected (step S104/YES), the processing proceeds to step S105. On the other hand, when no vehicle is detected (step S104/NO), the processing is repeated from step S103.

When the processing proceeds to step S105, the display device 10 performs a process of detecting an attribute of a user (step S105). Specifically, the detection unit 142 detects a sign displayed on the detected vehicle, and detects an attribute of the user riding in the vehicle based on the detected sign.

When an attribute has been detected (step S106/YES), the processing proceeds to step S107. On the other hand, when no attribute has been detected (step S106/NO), the processing proceeds to step S108.

When the processing proceeds to step S107, the detection unit 142 stores in the storage unit 130, information indicating the detected attribute of the user as the attribute information (step S107). After the storing, the processing proceeds to step S108.

When the processing proceeds to step S108, the display device 10 requests a content from the parking guidance device 30 (step S108). Specifically, the content request unit 143 transmits a content request to the parking guidance device 30. Note that when an attribute of the user is detected in step S106, the content request unit 143 includes attribute information indicating the detected attribute of the user in the content request and transmits the content request to the parking guidance device 30.

The parking guidance device 30 that has received the content request from the display device 10 performs content selection processing (step S109). After the content selection processing, the parking guidance device 30 transmits a selected content to the display device 10 (step S110). Note that details of the processing by the parking guidance device 30 will be described later.

The display device 10 that has received the content from the parking guidance device 30 displays the received content on the display unit 150 (step S111). Note that after step S111, the processing is repeated from step S101.

### (2) Flow of Processing by Parking Guidance Device 30

Next, a flow of the processing by the parking guidance device 30 will be described with reference to FIG. 8. FIG. 8 is a flowchart showing an example of the flow of the processing by the parking guidance device 30 according to the present embodiment.

As shown in FIG. 8, first, the parking guidance device 30 updates the weather information (step S201). Specifically, the weather information update unit 341 acquires weather information and updates the weather information stored in the storage unit 330.

Further, the parking guidance device 30 updates the congestion information (step S202). Specifically, the congestion information update unit 342 acquires congestion information and updates the congestion information included in the facility information stored in the storage unit 330.

Next, the parking guidance device 30 confirms whether a content request has been received (step S203). Specifically, when the request reception unit 343 has received a content request from the display device 10 (step S203/YES), the processing proceeds to step S204. On the other hand, when the request reception unit 343 has not received a content request from the display device 10 (step S203/NO), the processing is repeated from step S201.

When the processing proceeds to step S204, the parking guidance device 30 acquires route structure information and selection information (step S204). Specifically, the acquisition unit 344 acquires the route structure information from the facility information stored in the storage unit 330. Further, the acquisition unit 344 acquires the congestion information as the selection information from the facility information stored in the storage unit 330. Further, the acquisition unit 344 acquires the weather information stored in the storage unit 330 as the selection information. Further, when the content request includes attribute information, the acquisition unit 344 acquires the attribute information as the selection information.

Next, the parking guidance device 30 confirms whether the number of parking lots with the low congestion level is one (step S205). Specifically, based on the acquired congestion information, the parking area selection unit 345 confirms the congestion level of each of the plurality of parking lots indicated by the parking lot information included in the facility information stored in the storage unit 330. As a result of the confirmation, when the number of parking lots with the low congestion level is one (step S205/YES), the processing proceeds to step S206. On the other hand, when the number of parking lots with the low congestion level is not one (step S205/NO), the processing proceeds to step S207.

For example, in the case of the facility information shown in FIG. 5, there are two parking lots with the low congestion level, which are the parking lot P2 and the parking lot P3. Therefore, in the example shown in FIG. 5, since the number of parking lots with the low congestion level is not one, the processing proceeds to step S207.

When the processing proceeds to step S206, the parking area selection unit 345 selects a parking lot with the low congestion level (step S206). After the selection, the processing proceeds to step S210.

When the processing proceeds to step S207, the parking area selection unit 345 confirms whether the number of parking lots with the low congestion level is plural (step S207). Specifically, based on the acquired congestion information, the parking area selection unit 345 confirms the congestion level of each of the plurality of parking lots indicated by the parking lot information included in the facility information stored in the storage unit 330. As a result of the confirmation, when the number of parking lots with the low congestion level is plural (step S207/YES), the processing proceeds to step S208. On the other hand, when the number of parking lots with the low congestion level is not plural (step S207/NO), the processing proceeds to step S209.

For example, in the case of the facility information shown in FIG. 5, there are two parking lots with the low congestion level, which are the parking lot P2 and the parking lot P3. Therefore, in the example shown in FIG. 5, since the number of parking lots with the low congestion level is plural, the processing proceeds to step S208.

When the processing proceeds to step S208, the parking area selection unit 345 selects one parking lot from among the plurality of parking lots with the low congestion level, based on at least one of the weather information and the attribute information (step S208). Specifically, when the attribute information has been acquired, the parking area selection unit 345 selects one parking lot based on the weather information and the attribute information, and when the attribute information has not been acquired, the parking area selection unit 345 selects one parking lot based only on the weather information. After the selection, the processing proceeds to step S210.

For example, in the facility information shown in FIG. 5, when the weather condition is “good,” the parking area selection unit 345 selects the parking lot P3. On the other hand, when the weather condition is “bad,” the parking area selection unit 345 selects the parking lot P2. Further, when the attribute information indicates the user who prefers a route with a barrier-free structure, the parking area selection unit 345 selects the parking lot P3. On the other hand, when the attribute information indicates the user who does not need a route with a barrier-free structure, the parking area selection unit 345 selects the parking lot P2.

When the processing proceeds to step S209, the parking area selection unit 345 selects one parking lot from among the plurality of parking lots with the high congestion level, based on at least one of the weather information and the attribute information (step S209). Specifically, the parking area selection unit 345 selects one parking lot in the same manner as in step S208. After the selection, the processing proceeds to step S210.

When the processing proceeds to step S210, the content processing unit 346 selects a content corresponding to the parking lot selected by the parking area selection unit 345 (step S210). Specifically, the content processing unit 346 acquires from the storage unit 330, a content in which the parking lot selected by the parking area selection unit 345 is indicated as the guidance destination.

Finally, the output processing unit 347 transmits the content selected (acquired) by the content processing unit 346 from the communication unit 310 to the display device 10 (step S211). After transmitting the content, the processing is repeated from step S201.

Note that the processes from step S204 to step S210 in the flowchart shown in FIG. 8 are the detailed processes of the content selection processing in step S109 in the sequence diagram shown in FIG. 7. Further, the process in step S211 in the flowchart shown in FIG. 8 is the same process as the process in step S110 in the sequence diagram shown in FIG. 7.

As explained above, the parking guidance system 1 according to the present embodiment includes the acquisition unit 344, the parking area selection unit 345, and the output processing unit 347.

The acquisition unit 344 is configured to acquire route structure information indicating a structure on a route for a user of a facility to move from each of a plurality of parking lots to the facility, and selection information indicating information for selecting at least one parking lot from among the plurality of parking lots.

The parking area selection unit 345 is configured to select, from among the plurality of parking lots, a parking lot that allows access to the facility through a route with a structure suitable for the user, based on the acquired route structure information and the acquired selection information.

The output processing unit 347 configured to output to a display device, a content indicating the selected parking lot as a guidance destination.

With this configuration, a user of the facility according to the present embodiment can head to the guidance destination parking lot by confirming the content output on the display device 10. As the guidance destination parking lot, a parking lot that allows access to the facility through a route with a structure suitable for the user is selected. Therefore, after parking the vehicle at the guidance destination parking lot, the user can move from the parking lot to the facility using a travel route that is more suitable for the user than travel routes from other parking lots.

Therefore, the parking guidance system 1 according to the present embodiment can improve the convenience when users of a parking area move from the parking area where their vehicles are parked to the facility.

### 6. Modified Example

The embodiment of the present invention has been described above. Next, modified examples of the embodiment of the present invention will be described. Note that each modified example described below may be applied to the embodiment of the present invention singly, or may be applied to the embodiment of the present invention in combination. Further, each modified example may be applied in lieu of the configuration described in the embodiment of the present invention, or may be applied in addition to the configuration described in each embodiment of the present invention.

In the above-described embodiment, the example has been described in which the parking guidance system 1 regards one entire parking lot as one parking area and guides a user to a parking lot suitable for a user among a plurality of parking lots, but the embodiment is not limited to that example. For example, the parking guidance system 1 may regard each area in one parking lot divided into a plurality of areas as one parking area, and guide a user to a parking area suitable for the user among the plurality of parking areas in the one parking lot.

Further, in the above-described embodiment, the example in which the parking lot is a flat parking lot has been described, but the embodiment is not limited to that example. For example, the parking lot may be a multi-level parking lot. When the parking lot is a multi-level parking lot, each of the plurality of floors may be regarded as one parking lot. For example, in a case of a multi-level parking lot consisting of four floors from the first floor to the fourth floor, it may be assumed that there are four parking lots. In this case, for example, the first floor, the second floor, the third floor, and the fourth floor can be regarded respectively as the parking lot P1, the parking lot P2, the parking lot P3, and the parking lot P4 in the above-described embodiment.

As an example, it is assumed that a multi-level parking lot is an independent building, and only the third floor of a facility and the third floor of the multi-level parking lot are connected by an indoor connecting passage. It is also assumed that the multi-level parking lot has stairs, but no elevators. In this example, for example, when weather information indicating that the weather condition is “bad” is acquired, the parking area selection unit 345 selects the third floor as the guidance destination parking lot. Further, when attribute information indicating the user who prefers a route with a barrier-free structure is acquired, the parking area selection unit 345 selects the first floor as the guidance destination parking lot.

Further, in the above-described embodiment, the example in which only a content is displayed on the display device 10 has been described, but the embodiment is not limited to that example. For example, the display device 10 may display an image of a detected vehicle. In this case, the display processing unit 145 of the display device 10 displays on the display unit 150, the image of the vehicle detected by the detection unit 142. Note that the display processing unit 145 may display the image of the detected vehicle superimposed on the content, or may display the image of the detected vehicle without superimposition by dividing the display area of the display unit 150 into a display area for the content and a display area for the image of the vehicle.

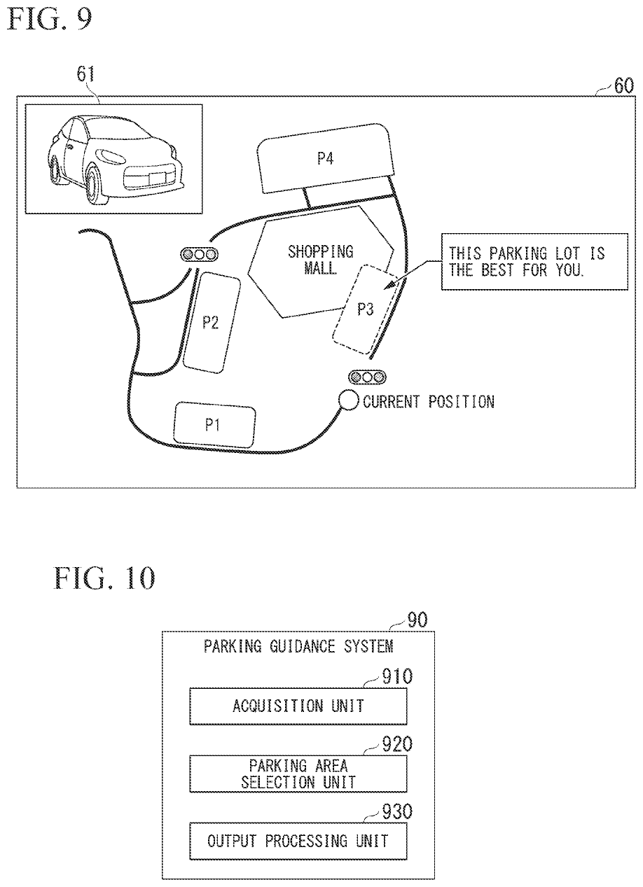

Here, a content in the modified example will be explained with reference to FIG. 9. FIG. 9 is a diagram illustrating an example of a content in a modified example of the present embodiment. In the example shown in FIG. 9, an image 61 of a detected vehicle is displayed superimposed on a content 60. In this way, by displaying the image of the detected vehicle together with the content on the display device 10, it becomes easier for the user to recognize for whom the content is being displayed. For example, when an image of a vehicle of a user is displayed on the display device 10, the user can recognize that a content displayed on the display device 10 is the content that is being displayed toward that user.

Further, in the above-described embodiment, the example has been described in which the parking area selection unit 345 selects a parking lot according to whether or not the user is a user who prefers a route with a barrier-free structure, based on the attribute information, but the embodiment is not limited to that example. For example, the parking area selection unit 345 may select a parking lot according to whether or not the user is a user who prefers to take a shuttle bus from the parking lot to the facility, based on the attribute information.

Further, in the above-described embodiment, the example has been described in which the imaging unit 220 of the imaging device 20 captures only an image showing the exterior of a vehicle as a captured image, but the embodiment is not limited to that example. For example, the imaging unit 220 may capture only an image showing the interior of the vehicle as the captured image. In this case, the detection unit 142 detects an attribute of a user from the captured image showing the interior of the vehicle.

Specifically, the detection unit 142 detects a vehicle from the captured image acquired by the image acquisition unit 141, and detects a user riding in the interior of the detected vehicle. Then, the detection unit 142 detects an attribute of the detected user. As an example, the detection unit 142 detects the number of users, age, gender, or the like as the attribute of the user. Thereby, the detection unit 142 can detect an attribute of the user even if a sign displayed on the vehicle cannot be detected from the captured image.

Further, the imaging unit 220 may capture both an image showing the exterior of a vehicle and an image showing the interior of the vehicle as captured images. In this case, the detection unit 142 detects an attribute of the user from each of both captured images.

Further, in the above-described embodiment, the example has been described in which the detection unit 142 detects as a sign, an elderly driver sign, a hearing impaired person sign, or a physically handicapped person sign from a captured image showing the exterior of a vehicle, but the embodiment is limited to that example. For example, the detection unit 142 may detect a license plate as a sign from the captured image showing the exterior of the vehicle. Then, the detection unit 142 may acquire attribute information of the user based on the detected license plate.

Specifically, first, users are asked to register their information and license plate numbers in advance. The detection unit 142 further detects a license plate number from the license plate detected from the captured image. Then, by referring to the registered information based on the detected number, the detection unit 142 can acquire the information registered in association with the detected number as the attribute information of the user. As a result, even when the detection unit 142 cannot detect an elderly driver sign, a hearing impaired person sign, a physically handicapped person sign, or a user inside the vehicle from the captured image, as long as the detection unit 142 can detect a license plate, the detection unit 142 can acquire the attribute information of the user.

Further, in the above-described embodiment, the example has been described in which the parking area selection unit 345 selects one parking lot as a guidance destination parking lot based on the selection information, but the embodiment is not limited to that example. For example, when the parking area selection unit 345 cannot narrow down the guidance destination parking lot to one based on the selection information, the parking area selection unit 345 may select a plurality of parking lots as the guidance destination parking lots.

Further, in the above-described embodiment, the example has been described in which the acquisition unit 344 acquires the congestion information, the weather information, or the attribute information as the selection information, but the embodiment is not limited to that example. For example, the acquisition unit 344 may also acquire as the selection information, distance information indicating a distance from the current position of the user (position of the display device 10) to each parking lot. The distance information is, for example, included in the facility information and stored in the storage unit 330 in advance.

Even if the parking area selection unit 345 uses the congestion information, the weather information, and the attribute information, the parking area selection unit 345 may not be possible to narrow down the guidance destination parking lot to one. Therefore, when the guidance destination parking lot cannot be narrowed down to one, the parking area selection unit 345 selects the parking lot closest to the current position based on the distance information. Thereby, the parking area selection unit 345 can narrow down the guidance destination to one.

Further, in the above-described embodiment, the example has been described in which the content processing unit 346 outputs the content acquired from the storage unit 330 as it is to the output processing unit 347, but the embodiment is not limited to that example. For example, the content processing unit 346 may process the content acquired from the storage unit 330 and then output the processed content to the output processing unit 347.

Further, in the above-described embodiment, the example in which the content is displayed on the display device 10 has been described, but the embodiment is not limited to that example. For example, the content may be displayed on a car navigation system installed in a vehicle of a user, or may be displayed on a smartphone, a tablet terminal, or the like carried by the user.

Note that all or part of the functions of the parking guidance system 1 in each embodiment described above may be realized by a computer. In that case, a program for realizing these functions may be recorded on a computer-readable recording medium, so that a computer system reads and executes the program recorded on the recording medium to realize the functions. Note that the “computer system” herein includes an OS and hardware such as peripheral devices. Further, the term “computer-readable recording medium” refers to portable media such as flexible disks, magneto-optical disks, ROMs, and CD-ROMs, and storage devices such as hard disks built into computer systems. Further, a “computer-readable recording medium” may include: a recording medium that dynamically stores a program for a short period of time, such as a communication line in a case where a program is transmitted via a network such as the Internet or a communication line such as a telephone line; and a recording medium that stores a program for a certain period of time, such as a volatile memory inside a computer system that serves as a server or client in that case. Further, the above-described program may be one for realizing a part of the above-described functions, or may be one that can realize the above-described functions in combination with a program already recorded in the computer system, or may be one realized using a programmable logic device such as an FPGA (Field Programmable Gate Array).

Although the embodiments of the present invention have been described above in detail with reference to the drawings, the specific configuration is not limited to those described above, and various design changes may be made without departing from the gist of the present invention.

Further, an example of a configuration of a parking guidance system 90 according to another embodiment of the present invention will be described with reference to FIG. 10. FIG. 10 is a block diagram showing an example of the configuration of the parking guidance system 90 according to another embodiment. As shown in FIG. 10, the parking guidance system 90 includes an acquisition unit 910, a parking area selection unit 920, and an output processing unit 930.

The acquisition unit 910 is configured to acquire route structure information indicating a structure on a route for a user of a facility to move from each of a plurality of parking areas to the facility, and selection information indicating information for selecting at least one parking area from among the plurality of parking areas.

The parking area selection unit 920 is configured to select, from among the plurality of parking areas, a parking area that allows access to the facility through a route with a structure suitable for the user, based on the acquired route structure information and the acquired selection information

The output processing unit 930 is configured to output to a display device, a content indicating the selected parking area as a guidance destination.

### DESCRIPTION OF REFERENCE SIGNS

1, 90 . . . parking guidance system, 10 (10-1 to 10-n) . . . display device, 20 (20-1 to 20-n) . . . imaging device, 30 . . . parking guidance device, 40 . . . content creation terminal, 50, 60 . . . content, 110 . . . communication unit, 120 . . . operation unit, 130 . . . storage unit, 140 . . . control unit, 141 image acquisition unit, 142 . . . detection unit, 143 . . . content request unit, 144 . . . display processing unit, 150 . . . display unit, 160 . . . power supply unit, 210 . . . communication unit, 220 . . . imaging unit, 230 . . . image processing unit, 240 . . . control unit, 250 . . . power supply unit, 310 . . . communication unit, 320 . . . operation unit, 330 . . . storage unit, 340 . . . control unit, 341 . . . weather information update unit, 342 . . . congestion information update unit, 343 . . . request reception unit, 344 . . . acquisition unit, 345 . . . parking area selection unit, 346 . . . content processing unit, 347 . . . output processing unit, 910 . . . acquisition unit, 920 . . . parking area selection unit, 930 . . . output processing unit

1. A parking guidance system comprising:
an acquisition unit configured to acquire route structure information indicating a structure on a route for a user of a facility to move from each of a plurality of parking areas to the facility, and selection information indicating information for selecting at least one parking area from among the plurality of parking areas;
a parking area selection unit configured to select, from among the plurality of parking areas, a parking area that allows access to the facility through a route with a structure suitable for the user, based on the acquired route structure information and the acquired selection information; and
an output processing unit configured to output to a display device, a content indicating the selected parking area as a guidance destination.

2. The parking guidance system of claim 1, wherein
the acquisition unit is configured to acquire as the selection information, weather information indicating a weather at the facility and the plurality of parking areas, and
the parking area selection unit is configured to select the parking area according to whether or not the route is a route provided with a structure corresponding to the weather indicated by the acquired weather information.

3. The parking guidance system of claim 2 wherein
when the acquired weather information indicates a weather condition under which a route provided with at least a roof is preferable, the parking area selection unit is configured to select a parking area that allows access to the facility through a route provided with at least a roof.

4. The parking guidance system of claim 1, wherein
the acquisition unit is configured to acquire attribute information indicating an attribute of the user as the selection information, and
the parking area selection unit is configured to select the parking area according to whether or not the route is a route provided with a structure corresponding to the attribute of the user indicated by the acquired attribute information.

5. The parking guidance system of claim 4, wherein
when the acquired attribute information indicates the user who prefers a route with a barrier-free structure, the parking area selection unit is configured to select a parking area that allows access to the facility through a route with a barrier-free structure.

6. The parking guidance system of claim 1, wherein
the acquisition unit is configured to acquire as the selection information, congestion information indicating a congestion level of each of the plurality of parking areas, and
the parking area selection unit is configured to select the parking area according to whether the congestion level indicated by the acquired congestion information is high or low.

7. The parking guidance system of claim 6, wherein
the parking area selection unit is configured to select a parking area with a low congestion level preferentially over a parking area with a high congestion level.

8. The parking guidance system of claim 1, further comprising:
an imaging unit configured to capture an image of at least one of an exterior of a vehicle and an interior of the vehicle; and
a detection unit configured to detect an attribute of the user from the captured image.

9. The parking guidance system of claim 8, wherein
the detection unit is configured to detect a sign displayed on the vehicle from the image of the exterior of the vehicle, and detect the attribute of the user riding in the vehicle from the detected sign.

10. The parking guidance system of claim 8, wherein
the detection unit is configured to detect the user riding in the vehicle from the image of the interior of the vehicle, and detect an attribute of the detected user.

11. The parking guidance system of claim 9, further comprising:
a display processing unit configured to display the image of the exterior of the vehicle on the display device.

12. A parking guidance method comprising:
acquiring route structure information indicating a structure on a route for a user of a facility to move from each of a plurality of parking areas to the facility, and selection information indicating information for selecting at least one parking area from among the plurality of parking areas;
selecting, from among the plurality of parking areas, a parking area that allows access to the facility through a route with a structure suitable for the user, based on the acquired route structure information and the acquired selection information; and
outputting to a display device, a content indicating the selected parking area as a guidance destination.

13. The parking guidance method of claim 12, further comprising:
acquiring as the selection information, weather information indicating a weather at the facility and the plurality of parking areas; and
selecting the parking area according to whether or not the route is a route provided with a structure corresponding to the weather indicated by the acquired weather information.

14. The parking guidance method of claim 13, further comprising:
when the acquired weather information indicates a weather condition under which a route provided with at least a roof is preferable, selecting a parking area that allows access to the facility through a route provided with at least a roof.

15. The parking guidance method of claim 12, further comprising:
acquiring attribute information indicating an attribute of the user as the selection information; and
selecting the parking area according to whether or not the route is a route provided with a structure corresponding to the attribute of the user indicated by the acquired attribute information.

16. The parking guidance method of claim 15, further comprising:
when the acquired attribute information indicates the user who prefers a route with a barrier-free structure, selecting a parking area that allows access to the facility through a route with a barrier-free structure.

17. The parking guidance method of claim 12, further comprising:
acquiring as the selection information, congestion information indicating a congestion level of each of the plurality of parking areas; and
selecting the parking area according to whether the congestion level indicated by the acquired congestion information is high or low.

18. The parking guidance method of claim 17, further comprising:
selecting a parking area with a low congestion level preferentially over a parking area with a high congestion level.

19. The parking guidance method of claim 12, further comprising:
capturing an image of at least one of an exterior of a vehicle and an interior of the vehicle; and
detecting an attribute of the user from the captured image.

20. A non-transitory computer-readable recording medium storing a program causing a computer to:
acquire route structure information indicating a structure on a route for a user of a facility to move from each of a plurality of parking areas to the facility, and selection information indicating information for selecting at least one parking area from among the plurality of parking areas;
select, from among the plurality of parking areas, a parking area that allows access to the facility through a route with a structure suitable for the user, based on the acquired route structure information and the acquired selection information; and
output to a display device, a content indicating the selected parking area as a guidance destination.
